(19) United States
(12) Patent Application Publication
(10) Pub. No.: US 2019/0359864 A1
(43) Pub. Date: Nov. 28, 2019

(54) Adhesive Composition for Bonding Shaped Parts Made of Plastic

(71) Applicant: Henkel AG & Co. KGaA, Duessldorf (DE)

(72) Inventors: Bernd Beuer, Monheim (DE); Rita Trauten, Duesseldorf (DE); Andre Baetzgen, Duisburg (DE); Bernhard Schoettmer, Monheim (DE)

(21) Appl. No.: 16/536,750

(22) Filed: Aug. 9, 2019

Related U.S. Application Data
(63) Continuation of application No. PCT/EP2018/054068, filed on Feb. 20, 2018.

(30) Foreign Application Priority Data
Feb. 23, 2017 (EP) 17157610.1

(51) Int. Cl. C09J 127/06; C08J 5/12; F16L 47/02

(52) U.S. Cl. CPC C09J 127/06; C08K 3/014; F16L 47/02; C08J 5/125

(57) ABSTRACT

The invention relates to the field of adhesives. More particularly, it relates to an agent for bonding shaped parts made of plastic, particularly plastic pipes, comprising a PVC-C resin with a K-value of ≤55 and butan-2-one as a solvent, as well as to a method for materially bonding plastic pipes, and a pipe composite consisting of at least two plastic pipes.

The invention is in the field of adhesives. It relates in particular to an agent for adhesively bonding molded parts made of plastics material, in particular plastics pipes, to a method for bonding plastics pipes, and to a pipe assembly consisting of at least two plastics pipes.

For adhesively bonding molded parts made of plastics materials, such as PVC, for example PVC pressure pipes, those adhesive bonding agents which contain a solid polymer dissolved in a suitable solvent or solvent system are common. The adhesive principle is based on the swelling capacity, solubility and diffusivity of the solvents. The solvents diffuse into the basic material, swell and, with the help of the polymer fraction introduced in dissolved form, form a bond when the joining parts are compressed. Over a period of time that cannot be precisely defined, the solvents desorb, so that a homogeneous compound is produced. This principle of adhesion technology is described, for example, in European patent application EP 0 197 481 A2. Said document describes a corresponding agent for adhesively bonding molded parts made of rigid PVC based on a PVC solution in a cyclic PVC-solvent-containing liquid solvent mixture at PVC solids contents of approximately 10 to 30 wt. %. The adhesive compounds described by way of example in said document all contain tetrahydrofuran and cyclohexanone as cyclic PVC solvents.

THF-free adhesive formulations based on a PVC solution in liquid solvent, which comprises 2-methyltetrahydrofuran, for adhesively bonding molded parts made of plastics materials, in particular of PVC, which have a prolonged open time and in particular also have a prolonged open time in thin layers, but still result in a very stable adhesive bond, are described for example in European patent application EP 2 687 571 A1.

Although it is desirable from a toxicological point of view to dispense with THF as a solvent, the known THF-free adhesives have disadvantages in the pressure resistance at elevated temperature, such as 60 to 80° C.

Proceeding from this known prior art, it was the object of the present invention to provide alternative adhesives having universal applications in terms of pressure, temperature and material for adhesively bonding molded parts made of plastics materials, in particular also ABS in addition to PVC. Such adhesive formulations should, in addition to high pressure and temperature resistance, also have a high storage stability and excellent compatibility with the plastics materials.

This object is solved by the subject matter of the present invention. It has surprisingly been found that the compositions according to the invention are pressure and temperature stable, i.e. have good pressure stability even at temperatures of 60° C. or even 80° C. In addition, they exhibit good storage stability, are compatible with the plastics materials, i.e. these materials are not damaged by the solvents contained, and have a special viscosity structure, which makes it possible to dispense with the use of thickeners.

The adhesive compositions according to the invention are characterized in that they are compositions based on a solution of a PVC-C resin in liquid solvent, the solvent comprising or consisting of butan-2-one.

In a first aspect, the invention therefore relates to an adhesive composition for adhesively bonding molded parts made of plastics material, in particular plastics pipes, comprising:
(1) at least one PVC-C resin having a K-value ≤55, preferably from 50 to 55, and preferably having a chlorine content 65%, preferably from 65 to 70%; and
(2) at least one liquid organic solvent in which the PVC-C resin is soluble, butan-2-one being contained as the liquid organic solvent.

In a further aspect, the invention relates to a method for bonding plastics pipes, in particular plastics pipes based on thermoplastic materials, by means of a fitting, in which method
(a) an adhesive is applied to the joining surface of the fitting and/or to the joining surfaces of the pipe ends to be connected thereby, and subsequently
(b) the pipes and fitting are pushed together, and subsequently
(c) the adhesive is left to cure, characterized in that an adhesive composition according to the invention is used as the adhesive.

Yet another aspect is directed to a method for bonding plastics pipes, in particular plastics pipes based on thermoplastics materials, in which method the pipe connection is produced by pushing together a first pipe end and a second pipe end, one pipe end being a receiving pipe part and the other pipe end being an insertion pipe part, an adhesive being applied to at least one of the joining part surfaces to be interconnected before the pipe ends are pushed together, and the adhesive being left to cure after the pushing together, characterized in that an adhesive composition according to the invention is used as the adhesive.

Finally, the invention also relates to a pipe assembly consisting of at least two plastics pipes with or without a fitting insert between the pipe ends, suitable for drinking water pipes, service water pipes and/or for pressure drainage, characterized in that the joining part surfaces of the interconnected joining parts are attached by means of an adhesive composition according to the invention.

In relation to an ingredient, the expression “at least one” refers to the type of ingredient and not to the absolute number of molecules. “At least one solvent” thus means, for example, at least one type of solvent, i.e. one type of solvent or a mixture of several different solvents can be used. Together with weight specifications, the expression relates to all compounds of the type indicated that are contained in the composition/mixture, i.e. that the composition does not contain any other compounds of this type beyond the indicated amount of the corresponding compounds.

Unless explicitly indicated otherwise, all percentages that are cited in connection with the compositions described herein refer to wt. %, in each case based on the relevant mixture.

“About” or “approximately” as used herein in connection with a numerical value relates to the numerical value±10%, preferably ±5%.

According to various preferred embodiments, the adhesive composition according to the invention comprises the at least one PVC-C resin in an amount of from 10 to 25 wt. %, preferably from 15 to 25 wt. %, in particular in amounts of from 17 to 23 wt. %, based on the total weight of the composition.

PVC-C is the abbreviation according to DIN EN ISO 1043-1:2002-06 for chlorinated polyvinyl chloride. Chlorinated polyvinyl chloride can be prepared in particular by chlorinating polyvinyl chloride (PVC) in the fluidized bed, dispersion or solution process and is usually marketed as a colorless powder having a chlorine content of preferably approximately 56-74% and a density of preferably approximately 1.5-1.64 g/cm³. In particular the thermal stability and heat resistance of the polyvinyl chloride are increased by the chlorination.

The PVC-C resin preferably used in the compositions according to the invention has a chlorine content of at least 65%, preferably from 65 to 70%.

Furthermore, the PVC-C resin used has a K-value of 55 or less, preferably from 50 to 55. The K-value and methods for its determination are known to a person skilled in the art. The K-value is a relative viscosity number which is determined at 25° C., preferably by analogy with DIN 53726 or ISO 1628-2. Suitable resins are described, for example, in international patent publication WO 2013/122458 A1 and can be prepared by chlorination starting from a PVC-U resin having a maximum K-value of 55.

The PVC-C resins used are soluble in the solvents used, i.e. have a solubility of more than 20 g/80 g solvent at room temperature (20° C.).

The adhesive composition according to the invention necessarily contains butan-2-one as the solvent. The amount of butan-2-one in the composition is usually from 40 to 90 wt. %, preferably from 50 to 85 wt. %, in particular from 70 to 83 wt. %.

Butan-2-one can be used as the sole solvent or in combination with one or more other cosolvents. Suitable cosolvents are, for example, selected from cyclic ethers, alkyl-substituted cyclic ethers, cyclohexanone, 2-methyltetrahydrofuran, 2-ethyltetrahydrofuran, tetrahydropyran, alkyl-substituted tetrahydropyran, methylal, ethylal, butylal, N-methyl-2-pyrrolidone, N-ethyl-2-pyrrolidone, furan, 2-methylfuran, 3-methylfuran and/or 2,5-dimethylfuran. Cyclohexanone, cyclopentyl methyl ether (CPME) and/or 2-methyltetrahydrofuran (2-MeTHF) are particularly preferred. However, the amount of such cosolvent in the composition is preferably up to 35 wt. %, more preferably up to 25 wt. %, still more preferably up to 10 wt. %.

In various embodiments of the invention, the compositions are substantially free of THF and/or aliphatic cyclic hydrocarbons having two oxygen atoms in the ring, such as dioxolane, in particular substantially free of THF. It may also be preferable for the compositions to be substantially free of N-methyl-2-pyrrolidone (NMP). The amount of such compounds in the compositions is therefore less than 20 wt. %, preferably less than 10 wt. %, advantageously less than 5 wt. %, more advantageously less than 1 wt. %, in particular less than 0.1% of tetrahydrofuran (THF) or aliphatic cyclic hydrocarbons having two ring oxygen atoms, such as dioxolane, or NMP. Most particularly preferably, the compositions are free of such compounds. “Free of” as used in this context means that the corresponding substance was not intentionally added, and is contained in particular in amounts of less than 0.5 wt. %, preferably less than 0.1 wt. %, more preferably less than 0.05 wt. %, most preferably less than 0.01 wt. %.

The total amount of solvent which is advantageously contained in the composition is preferably from 50 to 95 wt. %, more preferably from 60 to 90 wt. % and in particular from 70 to 85 wt. %, based on the total composition.

According to a preferred embodiment of the invention, a particularly preferred adhesive according to the invention comprises:
(1) from 10 to 25 wt. %, preferably from 15 to 25 wt. %, PVC-C resin;
(2) from 50 to 85 wt. %, preferably from 70 to 85 wt. %, butan-2-one;
(3) optionally from 5 to 35 wt. % of further solvents selected from cyclohexanone, cyclopentyl methyl ether (CPME) and 2-methyltetrahydrofuran (2-MeTHF).

In this case, the agent preferably contains less than 10 wt. %, more preferably less than 5 wt. %, advantageously less than 1 wt. %, and in particular no THF, and/or cyclic ether having 2 oxygen atoms in the ring, such as dioxolane, and/or NMP.

In various embodiments of the invention, the adhesive composition according to the invention may comprise stabilizers, such as those based on calcium, calcium zinc or tin. These are typically contained in said composition in amounts of up to 3 wt. %, such as from 0.1 to 3 wt. %, preferably from 0.2 to 2 wt. %, based on the total weight of the composition.

Furthermore, the composition may contain up to 10 wt. %, for example from 0.1 to 10 wt. %, preferably up to 5 wt. %, additives.

Additives of this kind include, for example, silica, preferably fumed silica, in particular hydrophilic fumed silica, preferably in amounts of from 0.05 to 4 wt. %, based on the total adhesive composition. The optional use of silica in combination with the remaining components leads to a further improved property profile of the adhesive compound, in particular with regard to the optimization of open time, storage stability and processability of the adhesive compound. In particular, hydrophilic fumed silica has been found to be suitable, preferably those having a specific surface area in the range of from 100 m²/g to 300 m²/g.

Furthermore, in a preferred embodiment of the invention, the adhesive composition according to the invention contains one or more metal soaps. Unlike the water-soluble sodium and potassium salts of saturated and unsaturated natural and synthetic fatty acids, resin acids and naphthenic acids, the less water-soluble metal salts of these acids are referred to as metal soaps. These may in particular be formulated with lithium, aluminum, magnesium, calcium, manganese, iron, zirconium, cerium, zinc, cobalt and/or vanadium as a cation. Particularly suitable optionally usable metal soaps are calcium stearate, calcium laurate, barium stearate, barium laurate, zinc stearate, zinc laurate and/or magnesium stearate. The most preferred optionally usable metal soap is calcium stearate.

The optionally usable metal soap, in particular calcium stearate, can advantageously be used in the adhesive in an amount of from 0.01 to 2 wt. %, in particular from 0.05 to 1 wt. %.

The optional use of the metal soap in combination with the remaining components likewise leads to a further improved property profile of the adhesive compound, in particular with regard to the optimization of open time, storage stability and processability of the adhesive compound. In particular, calcium stearate has been found to be suitable.

Furthermore, a carbonate salt may optionally be contained in the adhesive, preferably ammonium carbonate, advantageously in an amount of from 0.001 to 1 wt. %, in particular from 0.005 to 0.5 wt. %.

The optional use of the carbonate salt in combination with the remaining components also leads to a further improved property profile of the adhesive compound, in particular with regard to the optimization of open time, storage stability and processability of the adhesive compound.

The agents according to the invention may also contain synthetic thickeners, advantageously based on acrylate, such as preferably acrylate copolymers, in particular in amounts of from 0 to 2 wt %, for example from 0.01 to 0.1 wt. %. However, it is an advantage of the present invention that such thickeners, for example acrylate copolymers, can also simply be dispensed with, and nevertheless an adequate product consistency can be achieved. Among the synthetic thickeners which can be used, the copolymers and terpolymers of acrylic acid and methacrylic acid are the most important.

According to a preferred embodiment of the invention, the plastics molded parts to be adhesively bonded together according to the invention are pipes, fittings and/or pipe components, in particular those made of PVC or ABS. Of course, the invention may also be successfully used in all other plastics molded parts, such as gutters, sheet material, such as catch basins, housing boxes, etc.

The term “fitting” refers to the connecting pieces of a pipeline. These connecting pieces allow, for example, the in particular straight connection of pipe sections, but also pipe connections with change in direction or diameter, as well as the connection to mounting parts. The use of fittings allows in particular the simple adaptation of the pipeline course to the external conditions, i.e., for example, bypassing obstacles, implementing branches and diameter changes, etc. The course of a pipeline can therefore be easily adapted to the design requirements. The term “fitting” is used universally in pipeline design as well as in installation technology.

The invention enables permanently stable, high-strength connections of the molded parts, in particular it allows permanently stable, high-strength pipe connections which have a service life equal to the service life of a pipe and which meet the commonly accepted quality and testing requirements, as apply in particular also for pressure pipelines. The adhesive bond obtainable according to the invention has very good light-fastness, very good solvent resistance, very good resistance to hydrolysis, very good low- and high-temperature resistance and very good impact toughness. In particular, a very good shear strength of the adhesive bond can also be achieved. The adhesive is easy to apply, e.g. using a brush.

Within the meaning of the invention, any molded parts made of plastics material can be adhesively bonded, in particular those based on thermoplastic materials, preferably of PVC-U or PVC-C but also ABS (acrylonitrile-butadiene-styrene), ASA (acrylic ester-styrene-acrylonitrile) or ABS/ASA.

PVC, i.e. polyvinyl chloride, is well known to a person skilled in the art. It can be produced industrially in particular by suspension polymerization (S-PVC), microsuspension polymerization, emulsion polymerization (E-PVC) and bulk or mass polymerization (M-PVC), with suspension polymerization processes being by far the most important.

PVC-U is the abbreviation according to DIN EN ISO 1043-1:2002-06 for rigid PVC, which may have a plasticizer content of preferably from 0 to 12 wt. %. In particular, PVC-U-based molded parts to be adhesively bonded according to the invention contain no plasticizers. In contrast, flexible PVC has a plasticizer content >12 wt. %.

When connecting plastics molded parts, in particular PVS molded parts, the use according to the invention of the adhesive results in connections of excellent quality and durable stability, in particular in pipe connections of excellent quality and durable stability in the case of pipes.

The adhesive composition according to the invention is highly suitable for pipe bonding technology, even for use in corrosive media under high temperatures, but also for all other assembly and repair work with PVC-based materials (such as gutters). The adhesive composition according to the invention is also particularly suitable for construction gluing using PVC sheet material (such as catch basins, housing boxes).

The adhesives according to the invention give pressure resistances of at least 1000 h at temperatures of up to 80° C. and pressures of 8 bar after a curing time of 480 h+96 h and for pipes of ABS, PVC-C or PVC-U (determination according to EN 14814 or EN ISO 9311-3:2005). The shear strength (according to EN ISO 9311-2:2002) is >0.4 MPa after a curing time of 1 h, >1.5 MPa after 24 h, >10 MPa after 480 h+96 h. The adhesives thus comply with the DIN standard DIN EN 14814:2007.

The open time of the adhesives according to the invention is preferably 2 to 4 minutes and the storage stability is about 2 years.

Another object of the present invention is a method for bonding plastics pipes by means of a fitting, in which method
(a) an adhesive is applied to the joining surface of the fitting and/or to the joining surfaces of the pipe ends to be connected thereby, and subsequently
(b) the pipes and fitting are pushed together, and subsequently
(c) the adhesive is left to cure, an adhesive composition according to the invention as described above being used as the adhesive.

Another object of the present invention is a method for bonding plastics pipes, in which the pipe connection is produced by pushing together a first pipe end and a second pipe end, one pipe end being a receiving pipe part and the other pipe end being an insertion pipe part, an adhesive being applied to at least one of the joining part surfaces to be interconnected before the pipe ends are pushed together, and the adhesive being left to cure after the pushing together, an adhesive composition according to the invention as described above being used as the adhesive.

The adhesive can in principle be applied in every possible way in the methods according to the invention. However, it is preferred that the adhesive is applied with the aid of an application tool, in particular by brush application. As a result, a particularly uniform application in the desired adequate thickness can be achieved.

In order to achieve a particularly good connection of the plastics pipes with or without a fitting within the meaning of the invention, it is advantageous within the meaning of a preferred embodiment of the invention if the adhesive film thickness on the joining part surface before the joining together is in the range of from 0.1 mm to 2 mm, preferably from 0.2 mm to 1.5 mm, in particular from 0.2 mm to 0.6 mm. These adhesive film thicknesses in connection with the adhesive used result in pipe bonds having a very long service life in the case of plastics pipes, in particular PVC pipes.

By pushing together pipe and fitting or pipe and pipe, the adhesive bond between the joining part surfaces is made possible within the meaning of the invention. In order to be able to produce a very special, permanently secure pipe connection, the method according to the invention within the meaning of a preferred embodiment is advantageously to be designed such that pipe and fitting or pipe and pipe can be pushed together without twisting.

According to a preferred embodiment of the invention, the method according to the invention is characterized in that the pipes are pressure pipes.

Pressure pipes are known per se to a person skilled in the art and are used for pressure pipelines. A pipeline in which, in contrast with a gravity pipeline, a pressure greater than the atmospheric pressure prevails is known as a pressure pipeline. Pressureless applications, i.e. gravity feed lines or gravity pipelines, can of course also be implemented according to the invention.

The pipe connections which can be provided according to the invention can be used in particular for the transport of liquids, but water transport is particularly preferred.

However, other media are also readily transportable, such as glycol mixtures, which are used as a coolant, for example.

According to a preferred embodiment, the pipe connections according to the invention are therefore used in particular for drinking water pipes, service water pipes and/or for pressure drainage.

Another object of the present invention is a pipe assembly consisting of at least two plastics pipes with or without a fitting insert between the pipe ends, suitable for drinking water pipes, service water pipes and/or for pressure drainage, the joining part surfaces of the interconnected joining parts being attached by means of an adhesive according to the invention as described above.

All embodiments disclosed herein in connection with the adhesive can of course also be used for the uses and methods described, and vice versa.

### EXAMPLES

The following adhesives were prepared by mixing the components while heating to 40° C.:

### Formulation 1:

| | |
|---|---|
| Butan-2-one | 79.00 wt. % |
| PVC-C | 20.50 wt. % |
| Tin stabilizer | <0.50 wt. % |

Formulation 1 was prepared with three different PVC-C resins and tested for compressive strength of PVC-C pipes adhesively bonded thereby at 80° C. and 8 bar (according to EN ISO 9311-3:2005).

| | CPVC resin 1 | CPVC resin 2 | CPVC Resin |
|---|---|---|---|
| K-value | 52 | 50 | 57-60 |
| Chlorine content (%) | 67 | 68 | 64 |
| Density (g/l) | 620 | 480 | 228 |
| Solubility in MEK | Very good | Very good | Very good |
| Compressive | Passed | Passed | Unsatisfactory |
| strength at 80° C. | | | (cracks) |

The results show that only the PVC-C resins according to the invention having a K-value of 55 or less have the desired compressive strength at 80° C. with appropriate solubility.

1. An adhesive composition for adhesively bonding molded parts made of plastic material, comprising:
(1) at least one PVC-C resin having a K-value ≤55 and a chlorine content ≥65%; and
(2) at least one liquid organic solvent comprising butan-2-one.

2. The adhesive composition according to claim 1, wherein the at least one PVC-C resin is contained in an amount of from 10 to 25 wt. %, based on the total weight of the composition.

3. The adhesive composition according to claim 1, wherein the butan-2-one is contained in an amount of from 40 to 90 wt. %, based on the total weight of the composition.

4. The adhesive composition according to claim 1, wherein the composition further contains at least one cosolvent selected from cyclohexanone, cyclopentyl methyl ether (CPME) and 2-methyltetrahydrofuran (2-MeTHF).

5. The adhesive composition according to claim 4, wherein the at least one cosolvent is contained in an amount of up to 35 wt %, based on the total weight of the composition.

6. The adhesive composition according to claim 1, wherein the composition contains less than 0.1 wt. %, tetrahydrofuran (THF) or aliphatic cyclic hydrocarbons having two ring oxygen atoms.

7. The adhesive composition according to claim 1, wherein the composition is free of tetrahydrofuran (THF) or aliphatic cyclic hydrocarbons having two ring oxygen atoms.

8. The adhesive composition according to claim 1, wherein the composition further contains:
(1) at least one calcium-, calcium-zinc- or tin-based stabilizer; and/or
(2) at least one additive, based on the total weight of the composition.

9. The adhesive composition according to claim 1, comprising:
(1) from 10 to 25 wt. % PVC-C resin;
(2) from 50 to 85 wt. % butan-2-one;
(3) optionally from 5 to 35 wt. % of further solvents selected from cyclohexanone, cyclopentyl methyl ether (CPME) and 2-methyltetrahydrofuran (2-MeTHF).

10. A pipe assembly consisting of at least two plastics pipes bonded together by cured reaction products of the adhesive of claim 1.

11. A method for bonding plastic pipe to a fitting, comprising:
(a) applying the adhesive according to claim 1 to the joining surface of the fitting and/or to the joining surface of the pipe end to be connected thereby, and subsequently
(b) pushing the pipes and fitting together, and subsequently
(c) curing the adhesive to form a bonded pipe to fitting connection.

12. The method according to claim 11, wherein:
(a) the plastic pipe is comprised of a thermoplastics material selected from PVC-U, PVC-C, ABS, ASA or ABS/ASA; and/or
(b) the bonded pipe to fitting connection can withstand a pressure of 8 bar; and/or
(c) the bonded pipe to fitting connection is a component of drinking water piping, service water piping and/or for pressure drainage piping.

13. A method for bonding thermoplastic polymer pipes, comprising:
providing a first pipe having an end with an interior surface defining a receiving cavity;
providing a second pipe having an end with an exterior surface defining an insertion part;
applying the adhesive according to claim 1 to the interior surface and/or the exterior surface;
disposing the insertion part into the receiving cavity so that the adhesive is disposed therebetween to form a connection; and
curing the adhesive to bond the interior surface to the exterior surface.

14. The method according to claim 13, wherein:
(a) the plastic pipe is comprised of a thermoplastics material selected from PVC-U, PVC-C, ABS, ASA or ABS/ASA; and/or
(b) the bonded pipe to fitting connection can withstand a pressure of 8 bar; and/or
(c) the bonded pipe to fitting connection is a component of drinking water piping, service water piping and/or for pressure drainage piping.
